(19) United States
(12) Patent Application Publication
(10) Pub. No.: US 2006/0059012 A1
(43) Pub. Date: Mar. 16, 2006

(54) Automated medical record creation system

(76) Inventor: Christopher T. Thompson, Los Angeles, CA (US)

Correspondence Address: ATTN: CHRISTOPHER DARROW, ESQ.;GREENBERG TRAURIG LLP, SUITE 400E, 2450 COLORADO AVENUE, SANTA MONICA, CA, 90404, US

(21) Appl. No.: 10/938,253

(22) Filed: Sep. 10, 2004

(51) Int. Cl. G06Q 10/00

(52) U.S. Cl. 705/2; 715/700

(57) ABSTRACT

A system and method for creating and editing a medical database containing patient histories allows users to prepare a medical chart through color coded templates using interactive graphical user interfaces (GUIs).

### BACKGROUND

1. Field

This disclosure relates to a document generation system and method, and in particular to a user modifiable document for medical applications.

2. General Background and State of the Art

Medical documentation is the cornerstone for memorializing the patient encounter. There are multiple different audiences for the document, with different interests and requirements, such as billing and coding vendors, risk managers, attorneys (defense and plaintiff), administrators, governmental agencies, and other physicians and healthcare providers.

Many physicians have basic understanding of proper documentation and have a perception that there is little importance in properly documenting the patient encounter in spite of the fact that it is in their best interest.

Healthcare providers have little patience and a perception of little incentive for learning new technologies. Medical documentation chart creation must be intuitive, with a short learning curve, and must satisfy other audiences without inhibiting the workflow output from a care provider.

Since most providers have a specific practice methodology, or at least a perception of what the correct way to document an encounter, the program must be flexible to adapt to various documentation styles without losing the value proposition of prompting standard of care by subtly offering risk management, proper coding and billing, etc., by beginning with a medical document, or a chart, that satisfies the needs of various audiences.

The goal of creating a medical record (viz., medical charts) is to meet the expectations of the multiple, disparate audience members in the best possible way, without creating the perception of unnecessary time and effort investment by providers.

### SUMMARY

The present disclosure provides for automated preparation of medical charts in accordance with the requirements of establishments such as health insurance companies. A computerized system, possibly including a plurality of computer workstations, is utilized to facilitate in the preparation of medical charts and entry of data into the medical chart. The plurality of workstations may be further connected via a computer network to a centrally located server and/or a centrally located database.

The database comprises a plurality of templates, each template comprising a description of a medical condition, which is used to create the medical chart. The template may comprise a textual description, including a narrative for a particular condition, complaint, or ailment. The template may further include a combination of non-modifiable text and modifiable text (e.g., hyperlinks), or decision branch points, for further customizing the description and forming a more accurate rendering of the condition of the patient.

In an exemplary embodiment, in order to initiate preparation of a medical chart or to modify an existing chart, an active patient list is provided from which the user selects the desired patient. In one embodiment, patients are entered into a database through a separate interface such as a hospital information system or registration system. The active patient list is retrieved from the database. As the clerical staff registers a patient, selected data fields are passed from the database into the active patient list. If the patient is not already resident in the database and thereby not present in the active patient list, then a patient may be manually added to the database. For example, in the event of a power failure or other reason for loss of connectivity to the database, the user may manually add patients by selecting specific icons or functions.

In another aspect, the active patient list is color coded. For example, patient names may be highlighted based on color, where the color corresponds to the patient's status of evaluation. For example, the color green may indicate that the patient has not been assigned to and/or evaluated by a practitioner. It could also represent that there is no current complaint or no practitioner initials. Blue may represent a patient with a work-up in progress, or the patient is assigned to a practitioner and/or a complaint template is chosen and/or practitioner initials are present on the active patient list. The color red could represent that the work-up is completed and printed. Any combination of colors, alphabet styling (upper-case, bold-face, lowercase) may be used to give patient status in the active patient list.

The active patient list may also include information such as the patient's gender, age, chief complaint or reason for visit, the date/time of arrival, and the area of practice or department where they are being seen. Upon selecting a desired patient from the active patient list, a list of chief, or major, complaints is provided from which the user may select. Each of the complaints may further have a template associated with it. In one embodiment, the list of complaints is capable of being sorted via user commands such as mouse and/or keyboard strokes and/or via voice recognition.

The user first selects the chief complaint, and optionally, a secondary complaint. Thus, when at least one complaint is selected from the list, another screen having a template, comprising information describing the chief complaint, is displayed. As described above, the template may comprise a combination of non-modifiable text and modifiable text. In one embodiment, the modifiable text is hyperlinked words or phrases.

In one embodiment, selecting a portion of modifiable text opens a menu comprising a plurality of options which provide alternate descriptions for that portion of modifiable text. This feature allows the user to completely customize the description of the condition of the patient. The user can subsequently select at least one of the options, or phrases, from the menu thereby further qualifying or describing the medical condition. Alternatively, the user may can manually enter a description if an appropriate description is not presented, using a keyboard, mouse, microphone input to a speech recognition program or any combination thereof.

The modifiable text may for example be color coded in a manner to indicate that this portion of the text or description may be modified. Specifically, the modifiable text, from a menu with word lists, may have multiple colors (e.g., blue/green/brown/golden) wherein each color has a differing functionality. For example, blue choices may reflect multiple choice options, where the user can make one or more choices, and green choices may be single select choices. Alternatively, different typeface, fonts, boldface, italicized text may be used to distinguish the functionalities of various words.

Thus, as an example, if a blue colored modifiable word is “trauma”, then upon selecting “trauma” another menu of words further describing/clarifying trauma (e.g., head trauma, leg trauma, etc.) will appear on the screen for the user to select. The user may select any one or more of these condition specific words (viz., head trauma, leg trauma, etc.) so that they may be inserted in the chart.

Additionally, numbers may also be modifiable to describe, for example, when a patient has been admitted to a hospital. For example, the present system will allow the medical practitioner to select a specific medication, based on the diagnosed condition, for X number of days. The number X may be either entered through an appropriate interface such a calculator (e.g., of a type found in MS Windows) or entered manually as text.

There may be several sections on the patient's medical chart that may be easily modified via the menu driven system to allow pre-loaded words or phrases, describing the patient's medical condition, to be inserted into the chart. The user may simply apply a single keystroke to move from one modifiable word (or hyperlink) to another.

Any medical conditions not pre-loaded into the medical database may be easily programmed into the database using standard computer programming languages such as COBOL, C, BASIC, PASCAL, etc. Furthermore, phrases or words describing a medical condition of the patient that were pre-loaded into the database and selected by the user on the screen may be deleted (for that patient), and subsequently new words/phrases may be directly entered into the chart either via a keyboard or through a microphone used in conjunction with a speech recognition software for that patient.

Furthermore, there may be options to delete a patient, print the chart of the patient, and archive the patient in the database. In addition, preformatted medical excuses, based on ailments, may be loaded on a chart from the database for the patient. The chart may be sorted according to patients that belong to various practitioners, the severity of their ailments, and other conditions.

In one embodiment, the input means is through voice recognition and touch screen. For example, the user may speak commands for inserting words/phrases into a microphone, and voice recognition software (such as Dragon available from ScanSoft Inc.) may be used for converting speech input into actions. Alternatively, a keyboard, mouse or other input methods such as a combination of speech, touch screen, and keyboard input may be used.

The foregoing and other objects, features, and advantages of the present disclosure will be become apparent from a reading of the following detailed description of exemplary embodiments thereof, which illustrate the features and advantages of the disclosure in conjunction with references to the accompanying drawing Figures.

### BRIEF DESCRIPTION OF THE DRAWINGS

FIG. 1 is a screen shot illustrating a login screen in an exemplary embodiment.

FIG. 2 is a screen shot from an exemplary embodiment illustrating an active patient list.

FIG. 3A is a screen shot from an exemplary embodiment illustrating a chief complaint template graphical user interface (GUI).

FIG. 3B is a screen shot from an exemplary embodiment illustrating a modifiable template selected from a list of chief complaints.

FIG. 4 is a screen shot from an exemplary embodiment illustrating a medical chart.

FIG. 5 is a screen shot from an exemplary embodiment illustrating a menu comprising multiple choice points.

FIG. 6 is a screen shot from an exemplary embodiment illustrating the operation of selecting a navigation tab so as to move the position of the chart, on the screen, to the selection.

FIG. 7 is a screen shot from an exemplary embodiment illustrating the operation of selecting a navigation tab so as to open the context menu for that tab.

FIG. 8 is a screen shot from an exemplary embodiment illustrating a chief complaint GUI in the main chart.

FIG. 9 is a screen shot from an exemplary embodiment illustrating the operation of changing the “History of Present Illness” template, via a menu driven system, after it is made available for selection in the main chart.

FIG. 10 is a screen shot from an exemplary embodiment illustrating selectable top level headers.

FIG. 11 is a screen shot from an exemplary embodiment illustrating grayed out or inactive top level headers, of FIG. 10, that can be made active by a user.

FIG. 12 is a screen shot from an exemplary embodiment illustrating the operation of deleting selected text from the medical chart.

FIG. 13 is a screen shot from an exemplary embodiment illustrating the modality for adding text to an existing record in the medical chart is by opening a word list at a choice point.

FIG. 14 is a screen shot from an exemplary embodiment illustrating the modality for adding text to an existing record in the medical chart is by opening a word list at a choice point.

FIG. 15 is a screen shot from an exemplary embodiment illustrating modifiable text (or choice points), in the medical chart, pertaining to the time of arrival of the patient.

FIG. 16 is a screen shot from an exemplary embodiment illustrating a GUI for inserting alphanumeric characters at specific modifiable choice points (e.g., the time of arrival choice point of FIG. 15).

FIG. 17 is a screen shot from an exemplary embodiment illustrating a “Past Data” GUI for allowing portions or previous patient records to be imported into a medical chart.

### DETAILED DESCRIPTION

In the following description of the preferred embodiments reference is made to the accompanying drawings which form a part thereof, and in which are shown by way of illustration specific embodiments in which the invention may be practiced. It is to be understood that other embodiments may be utilized and structural and functional changes may be made without departing from the scope of the present invention.

The medical database and chart system according to an exemplary embodiment includes a login window that is displayed on the screen. Typically, the user may be presented with a Graphical User Interface (GUI) for creating a medical record. For example, in the GUI, there may be buttons such as the a start button.

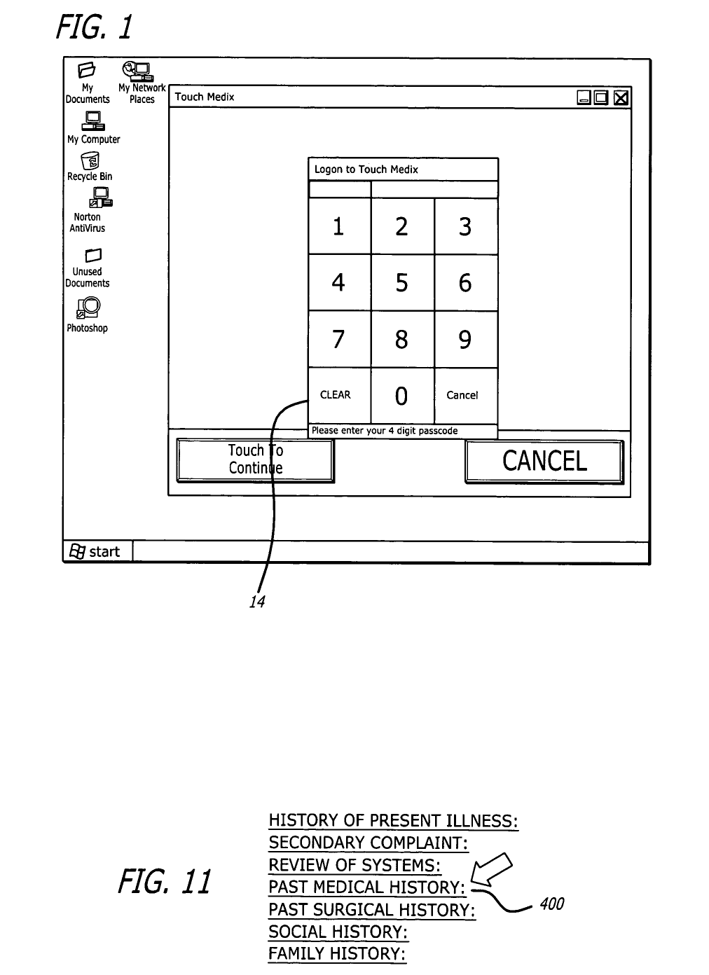

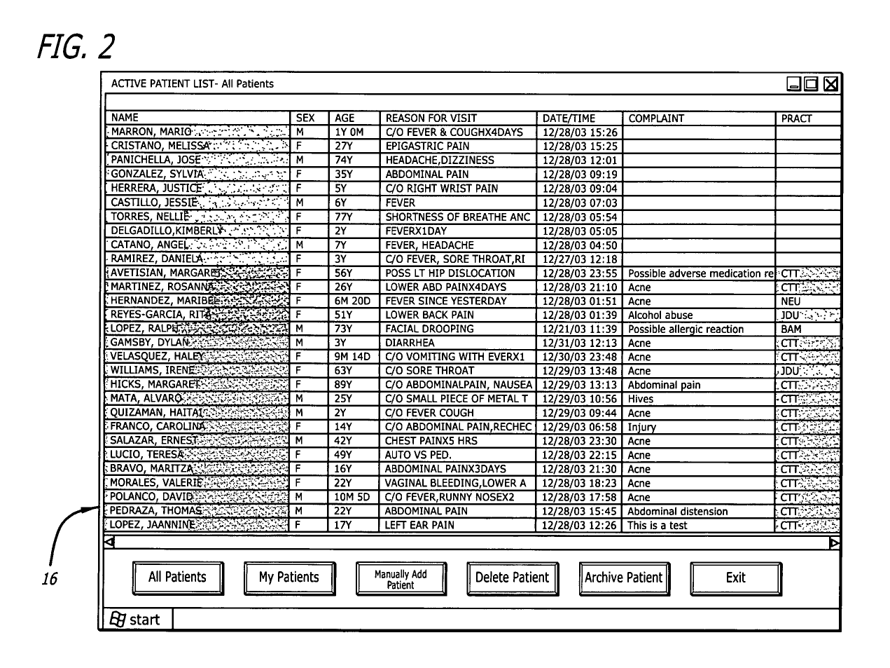

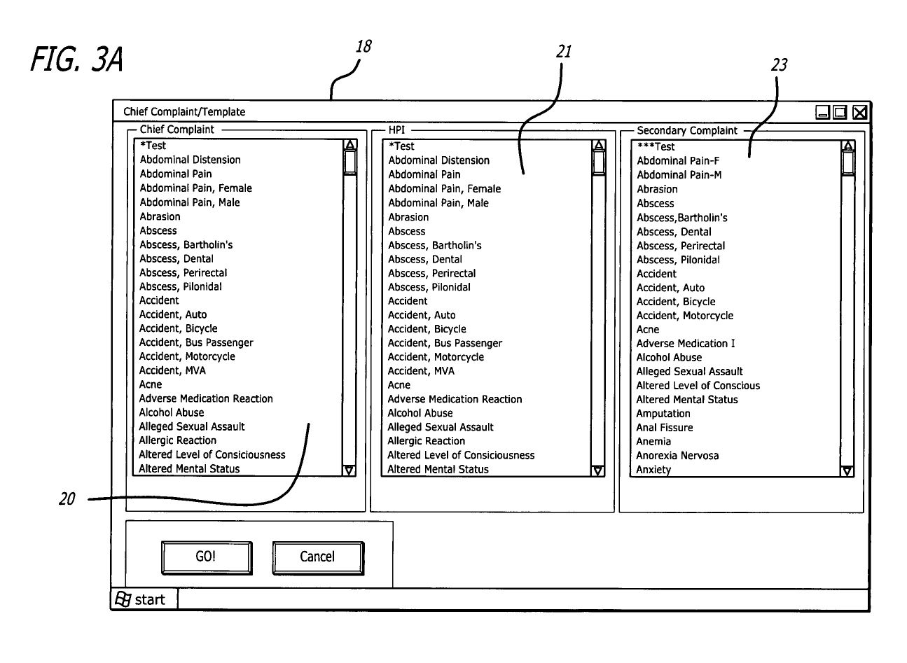

On selecting the start button, a logon screen 14 (FIG. 1) may appear to prevent unauthorized access to the system. Upon entering the necessary authentication information (e.g., password) a window having the active patient list 16 opens (FIG. 2). The active patient list, in FIG. 2, includes a color coded listing of current and past patients as well as the practitioners that are or were treating these patients. In FIG. 2, for exemplary purposes, the names in the active patient list have been shaded and/or textured as a representation for color coding. Furthermore, a concise description of the problems of each of these patients are listed adjacent the patients. The color coding is done, for example, such that green background patients are not assigned to a practitioner and may contain no data. Blue patients are in progress, and may contain data and have an assigned practitioner, whereas red patients may have an assigned practitioner, contain data, have been printed and are ready for archiving and removal from the active patient list. After logon, a new (for e.g., green color coded) patient may be selected from the active patient list of FIG. 2. Clicking or selecting a green color coded patient, for example, will open a chief complaint template or GUI 18 (FIG. 3A). In this menu, the medical practitioner can select templates for conditions or symptoms exhibited by the patient. Specifically, multiple windows are provided for the practitioner to select various conditions for the patient. For example, frame 20 is provided for selecting the chief or major complaint that the patient is exhibiting. The History of Present Illness (HPI) window, as shown as 21 in FIG. 3A, allows the practitioner to select some templates pertaining to the health problem of the patient, while window 23 allows secondary/tertiary symptoms to be selected if needed. Additionally, in another aspect, and as shown in FIG. 3B, upon selecting at least one of the complaints, from the window 20, the system will provide a template with detailed description of the corresponding complaint in a window 22. The practitioner has an option to edit the template for the corresponding patient by selecting the edit complaint icon 24.

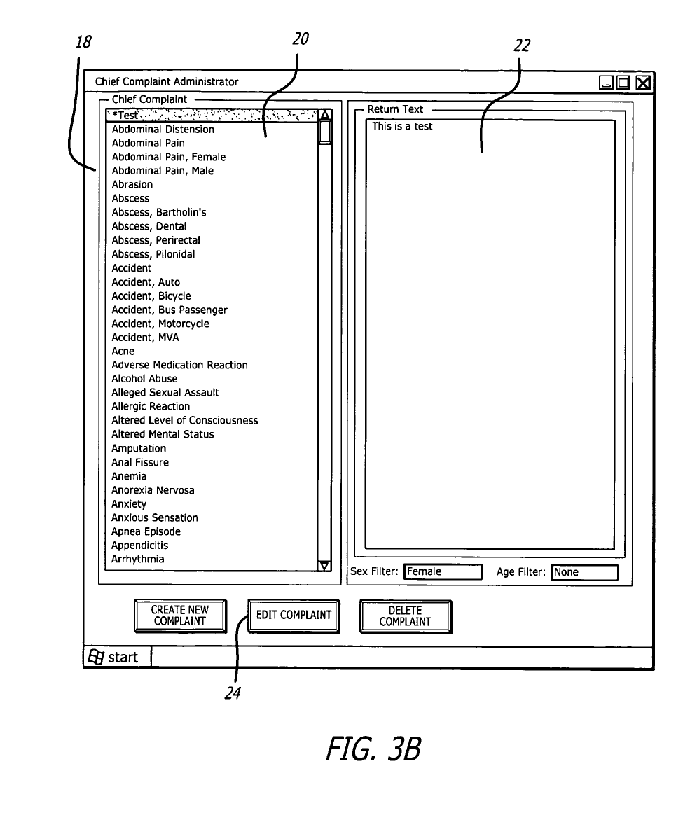

After selecting the appropriate symptom related templates, such as the Chief Complaint and the History of Present Illness (HPI) template (FIG. 4), the medical chart, having information from these templates, opens as shown in FIG. 4. The default chart for the selected chief complaint 26 and HPI Template 28 occupies a portion of the screen. Other areas of the screen include the title bar 30, menu bar 34, navigation tabs 32, previous records and navigation cube 36. The user may navigate through the chart by using appropriate navigation tabs and buttons (e.g., the move button 38).

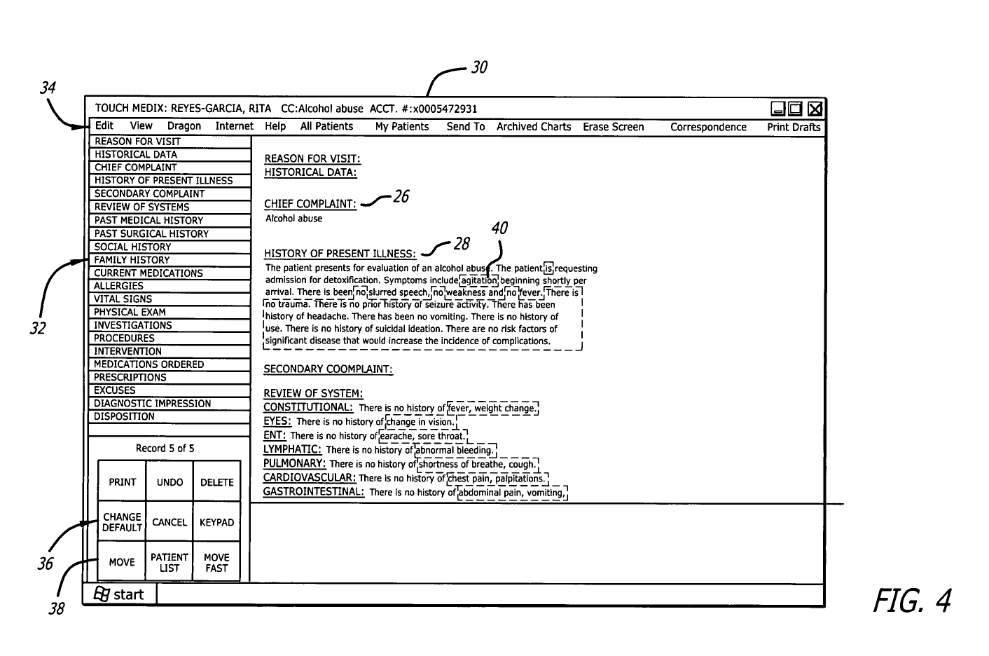

Selecting the move button 38 in the navigation cube 36 causes the cursor to jump to a choice point, for example depicted by 40, causing it to be highlighted. Choice points (or modifiable text) are branching points, for specific words or phrases, that allow the medical practitioner to further quantify or qualify the medical condition of the patient. For example, touching on a modifiable text or choice point 42 (FIG. 5) may open a word list 44 for allowing the user to further quantifying or qualifying the medical condition of the patient. Thus, a choice point may identify modifiable text, wherein said modifiable text could be modified via the word list.

The user or practitioner may then select different choices from the word list for inserting into the medical chart. For example, if the modifiable text or choice point is “other abdominal findings” 42, then selecting this choice point 42 will open numerous options that further qualify “other abdominal findings”. For example, as shown by window 44, the various options may include text such as, “Ascites”, “Colostomy”, etc. Depending on the color code for the choice point (i.e., modifiable text) additional text may further be selected from a window 44. For example, if the modifiable text is green, then this could indicate a single select choice point and the window may close automatically after selection of qualifying text from the opened window (e.g., 44). If the modifiable text is blue, multiple options may be available in the window after selection of this text. In the drawings, instead of colors, dashed outline boxes, solid line boxes, and/or shaded boxes are used to represent different colors.

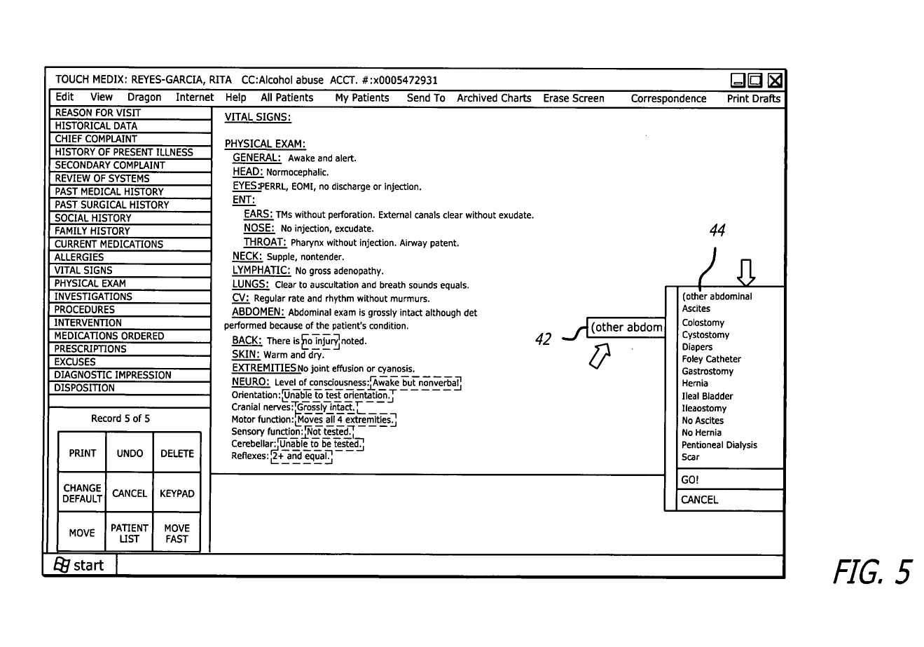

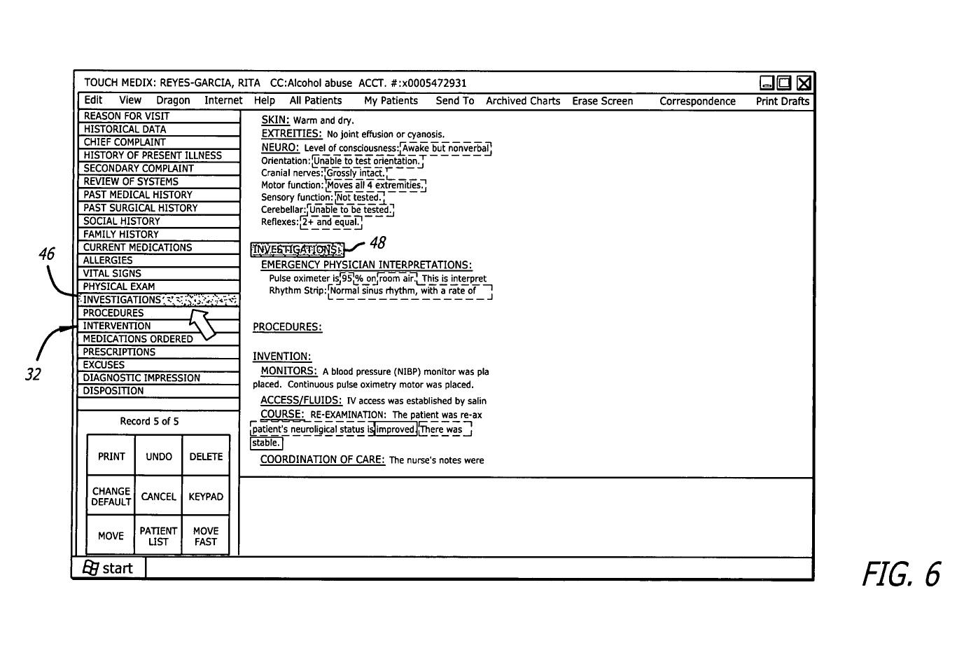

Single selection of a navigation tab 32 causes said tab to be highlighted and the position of the chart moves to that selection. As an example, selecting the “Investigations” navigation tab 46 in FIG. 6 will cause the position of the chart to move to selection 48. As shown in FIG. 7, selecting a header tab 52 in the chart opens a context menu 50 for that tab (FIG. 7).

Selecting a color coded (e.g., green) choice 54 will cause the context menu 50 to close and the text for the selection placed in the chart. Selecting another color coded choice (e.g., blue 56) will cause the context menu to place a check mark by the selection. When all selections are chosen, the user may select the “GO!” button 58 to close and to add the text for the selection(s) directly in the chart 60.

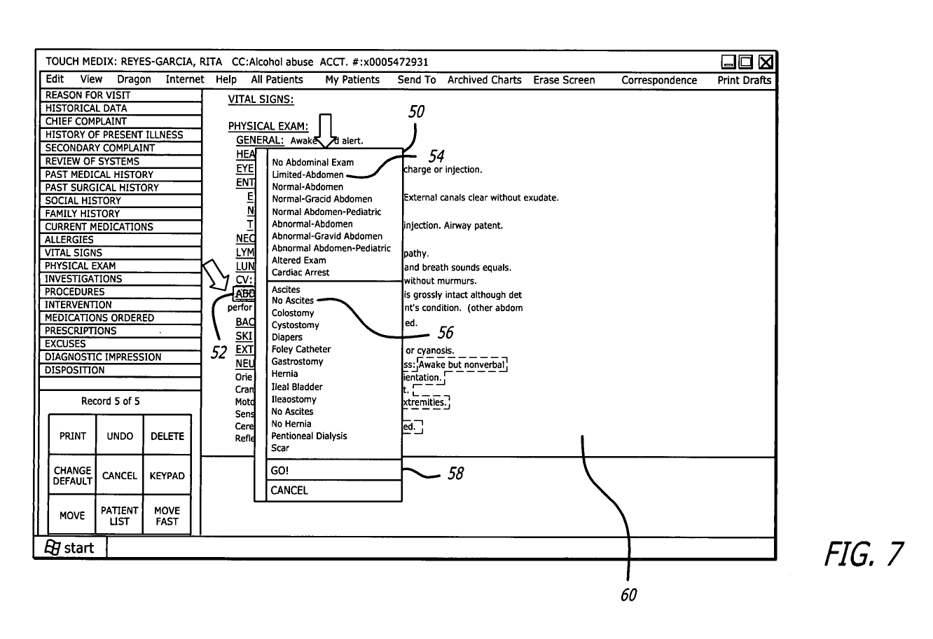

The chief complaint GUI 80 (FIG. 8) in the main chart 60 may be edited by simply selecting the “Chief Complaint” header 81 and selecting a choice from the opened GUI 80. The user can cancel the selection by clicking on the cancel button 82.

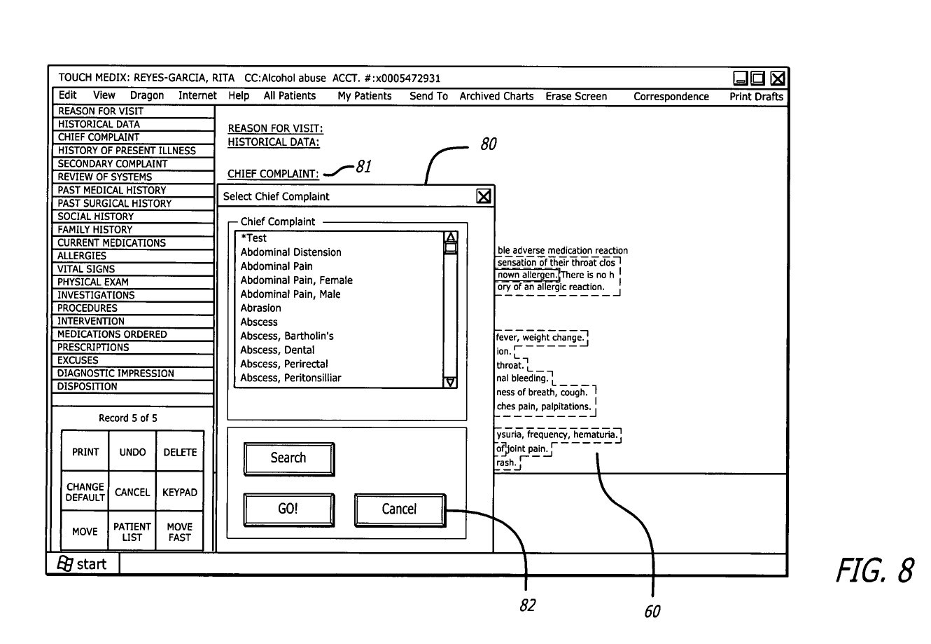

The “History of Present Illness” template 90 (FIG. 9) is the template selected for documenting the patient encounter. A “template” is a pre-programmed, structured guide to assist the user documentation of the medical record. The user may select a different chief complaint from the “History of Present Illness (HPI)” or the reverse and furthermore the opportunity to change the HPI template 90 can be made available by means of a GUI 92. Thus to change the HPI, the user is requested to first select the top level header for “History of Present Illness” 94, then select the “Change HPI” option 96, and finally selecting a confirmation button to change the HPI template. Upon selecting “Yes”, the chief complaint GUI 18 opens (e.g., the GUI in FIG. 3A), and the user may select a new HPI Template, Chief Complaint, and Secondary Complaint.

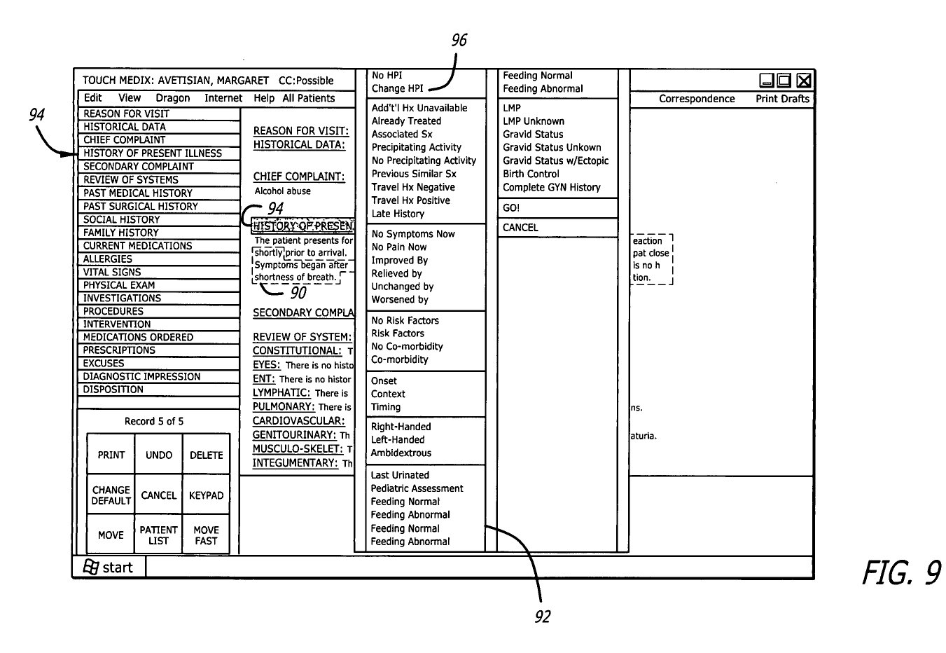

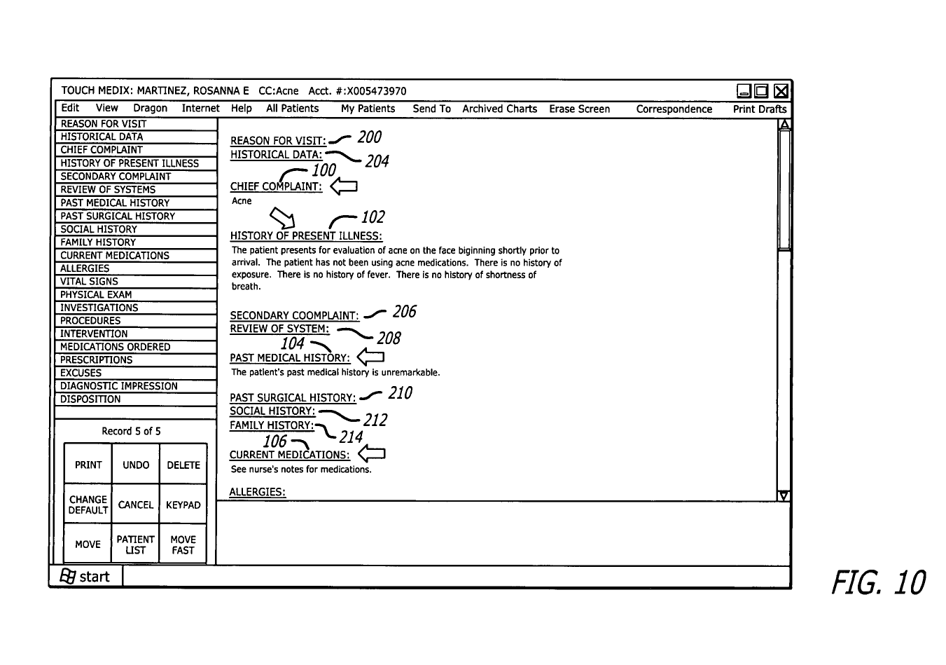

A color coded top level header, such as black (e.g., 100, 102, 104, 106), as shown in FIG. 10, is an active header that contains data and prints to a printer. A grayed out top level header (e.g., 200-214) is an inactive header and contains no data and does not print. Either of the top level headers may be designed not to be deleted from the program. In order to change an inactive header to an active header, the user is requested to select the grayed out top level header (e.g., 400 in FIG. 11) to open the context menu, and the user may then select options from the context menu to make the inactive header an active header. To perform the reverse operation (i.e., to change an active header to an inactive header) the user may select the appropriate top level header, or the corresponding navigation tab, which will open the context menu. Selecting any green color coded word will cause the context menu to close and the top level header to become gray or inactive. Any previous text associated with the top level header, while it was active, may be automatically deleted.

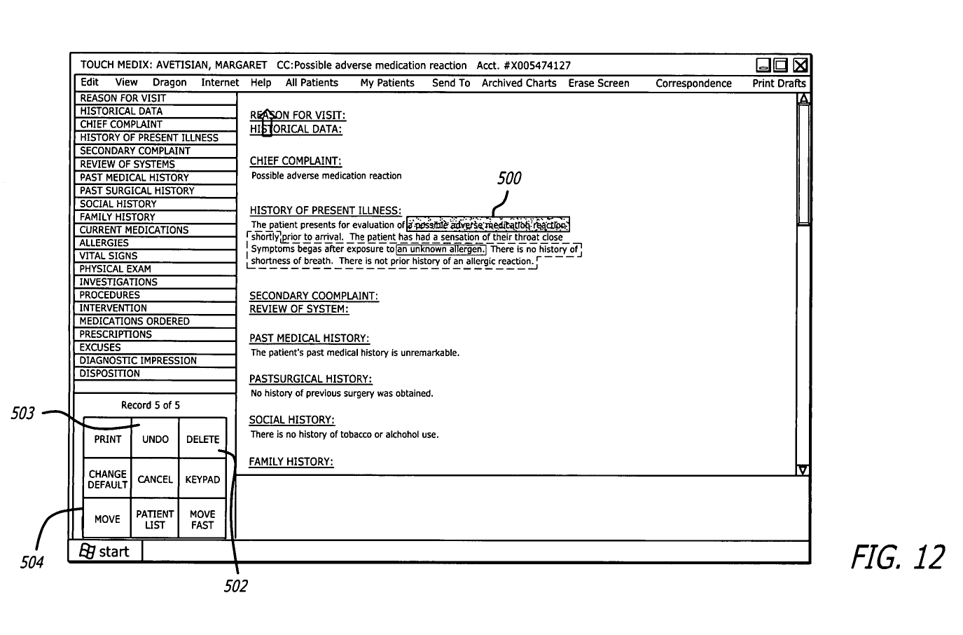

When a template is opened, default text specific for the complaint appears. To delete existing text, the user may highlight text to be deleted such as shown through 500 (FIG. 12). To this end, the user may select the text that is to be deleted, then touch the “DELETE” button 502 in the navigation cube 504 at the bottom left corner in one aspect. The top level headers could be designed such that they won't be inadvertently deleted, whereas any secondary or lower level header could be designed to be deleted. With regards to the “UNDO” button 503, this button can “undo” previous choices, such as deleting. This functionality may be unlimited in its number of “undo”s.

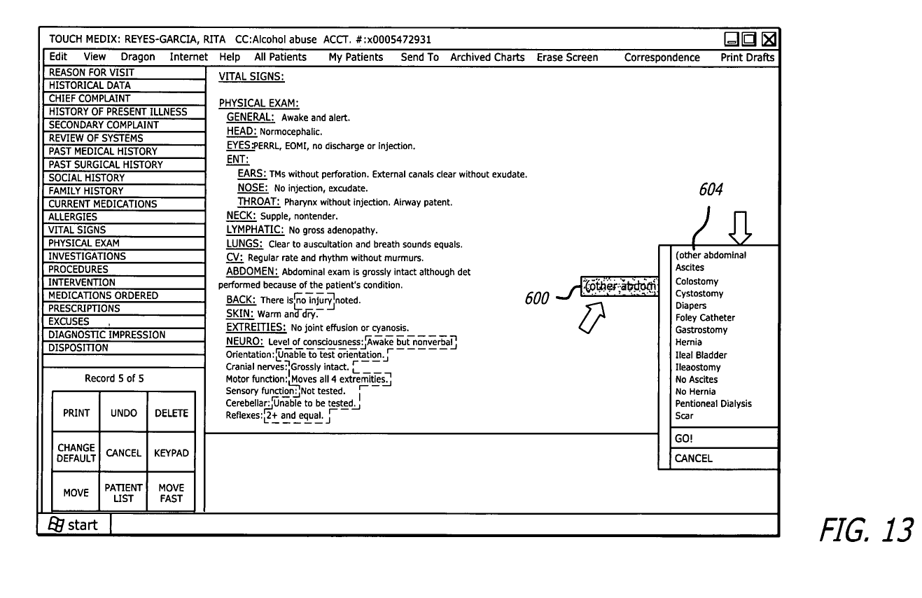

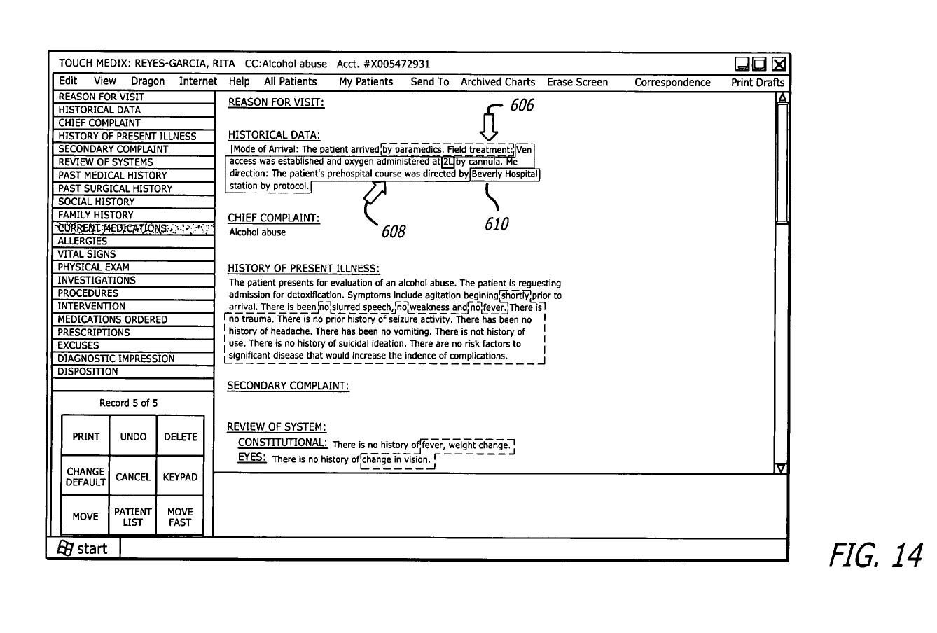

One modality for adding text to an existing record is by opening a word list at a choice point or at a place where the text is modifiable (e.g., 600 in FIG. 13) and choosing alternative text from a list 604 (as shown by the selections). Other options are voice-to-text speech recognition software such as the one available from Dragon Software. Specifically, as mentioned earlier, color coded text (e.g., blue text 606 in FIG. 14) may designate where there is a choice point or modifiable text, red text 608 designates where there is a choice point, within a choice point; and, golden text 610 may designate where there is a choice point, within a choice point, within a choice point. The user may touch any level choice point, blue, red or golden and choices for that level will open. Selecting a particular color coded choice point, blue, red or golden, opens a word list with substitution choices available. Specifically, blue word list Items are associated with multiple select choices, green word list Items are single select choices.

In another exemplary aspect, the modality for adding text to an existing record is by opening a word list at a different color coded choice point (e.g., brown color coded) and choosing alternative text. Specifically, for example, brown text may designate where there is a choice point, but unlike blue text, red text or golden text, brown text displays and opens a word list but does not print. In other words, brown color text may be a placeholder for a word list.

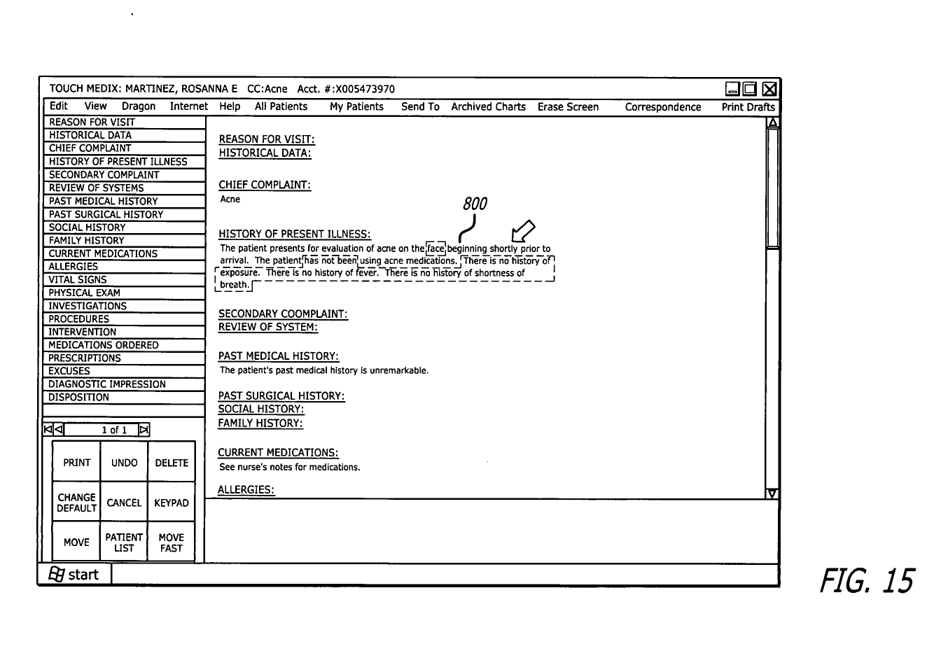

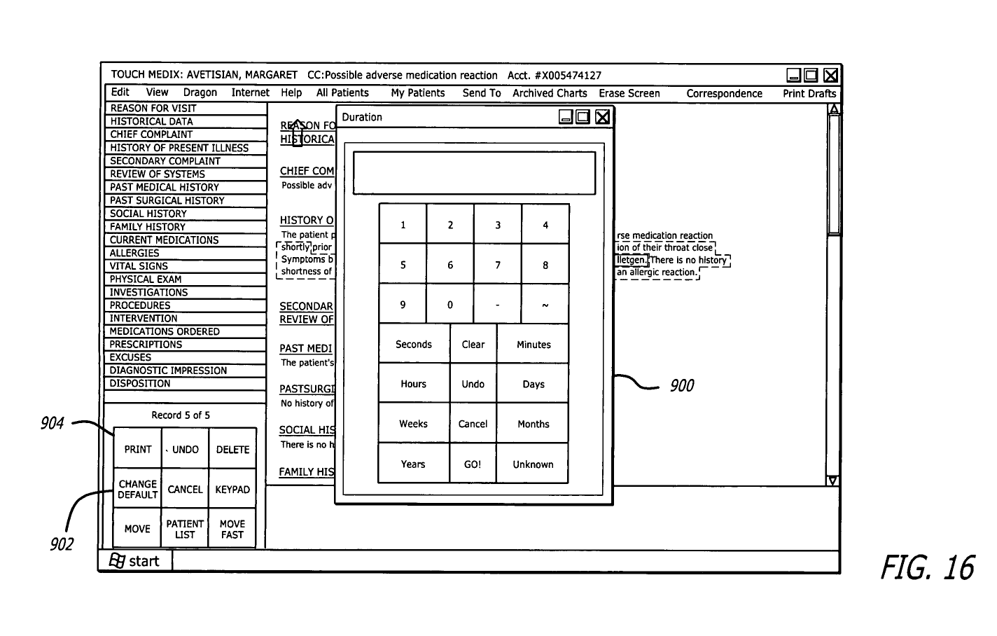

Some of the HPI Templates may begin with a first line indicating why the patient is being evaluated and could state, “ . . . beginning shortly prior to arrival” (for e.g., FIG. 15, 800). Touching this choice point opens a special GUI (FIG. 16, 900) for recording and quantifying time. Specifically, the user may change shortly to a different time by selecting the phrase that includes the word “shortly” to open the duration GUI 900. Then the user may select the appropriate number (days, weeks, months, etc.) to record the duration of symptoms.

In another embodiment, if a user edits a template for a selected patient then the “Change Default” button 902 saves these edits as a new “default” text for the selected template.

Additional features to the present system include saving the chart for future use, adding and deleting patients, printing a chart. The system may also include templates for common excuses and may include various options such as, the user being able to load up the duration GUI for customizing the excuse. Additionally, the user may be able to include the ailment/condition from the chief complaint menu. The users may be able to view and select specific patients pertaining to particular practitioners, and may be able to manually add more patients to the database system.

A user may enter the administrator mode if that user has administrator privileges. In this general area changes may made to the various administrator features. There are at least the following features that an administrator may edit: (i) HPI Templates (in this GUI, templates may be edited, added, deleted), (ii) Chief Complaints (in this GUI, chief complaints may be edited, added, deleted), (iii) Word Lists (in this GUI, word lists may be edited, added, deleted), (iv) Context Menus (in this GUI, context menus may be edited, added, deleted), (v) Medications Ordered (in this GUI, medications ordered may be edited, added, deleted), (vi) Current Medications (in this GUI, current medications be edited, added, deleted), (vii) Prescriptions (in this GUI, prescriptions may be edited, added, deleted), (viii) Practitioners (in this GUI, practitioners may be edited, added, deleted), (ix) Setup (in this GUI, printer options and other management features may be edited, added, deleted).

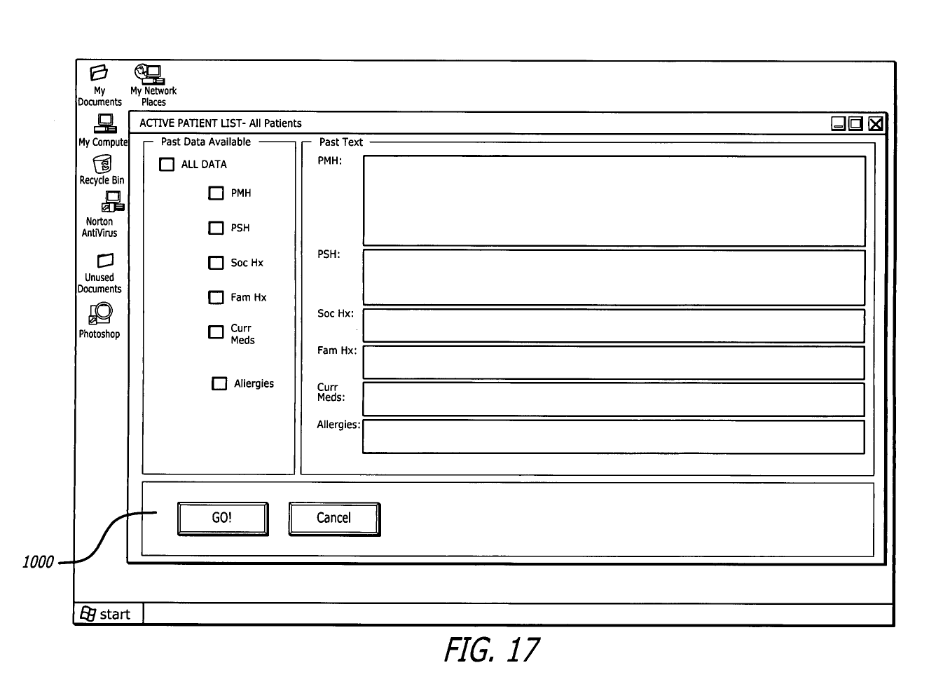

Other aspects of the present system may allow the user to clone patient information. Specifically, certain portions of a patient's previous chart may be “cloned” into the current chart. The “Past Data” GUI 1000, of FIG. 17, allows portions or all of previous patient records such as Past Medical History (PMH), Past Surgical History (PSH), social history, family history, current medications, allergies, and other information to be incorporated into the current chart, for appending, editing or deletion.

The user may also be able to add multimedia content to the patient information. Examples of Multimedia content include scanned documents and pictures, including EKGs, handwritten notes and digital camera pictures. There may also be a feature in the system to allow voice training of users that are to be allowed access to the system. This enables voice activation of various menu features in the chart.

The foregoing description of exemplary embodiments of the invention has been presented for the purposes of illustration and description. It is not intended to be exhaustive or to limit the invention to the precise form disclosed. Many modifications and variations are possible in light of the above teaching.

What is claimed is:

1. A computer assisted method of creating a medical record for a patient, the method comprising the steps of:
providing a list of active patients from which to select a patient to create a record for;
providing a list of a plurality of medical conditions from which to select a chief complaint;
providing a plurality of templates, each template corresponding to a medical condition and comprising a textual description of the medical condition, wherein at least a portion of the textual description includes modifiable and non-modifiable text, the modifiable text further providing a plurality of options to further describe one aspect of the medical condition.

2. The method of claim 1 wherein the modifiable text is color coded.

3. The method of claim 1 further including the step of inserting an unit of time, through a graphical user interface, for describing at least one of a duration of symptoms for the medical condition, duration of medical treatment, amount of dosage for treating the medical condition.

4. The method of claim 1 wherein the record is edited through at least one of a keyboard, mouse, or voice recognition software.

5. The method of claim 1 further including the step of selecting at least one of a menu bar, navigation cube, title bar, or navigation tab.

6. The method of claim 1 further including the step of deleting at least one of the modifiable text or non modifiable text from the chart using at least one of a keyboard, mouse, or voice recognition software.

7. The method of claim 1 further including the step of adding either a modifiable or non-modifiable text to the record for describing the medical condition of the patient.

8. The method of claim 1 further including the step of storing multimedia information comprising at least one of an EKG, pictures, voice segments, of the patient.

9. A computer assisted system of creating a medical chart for a patient, the system comprising:
means for selecting at least one of a plurality of medical conditions from the list relating to the condition of the patient;
a template that includes description related to the selected medical condition; and
means for incorporating description from the template, describing the medical condition, into a chart;
said chart including at least one modifiable text and at least one non modifiable text, said modifiable text being color coded to provide a plurality of options to further describe one aspect of the medical condition;
wherein selection of the modifiable text opens a menu of the plurality of options for insertion into the chart.

10. The system of claim 9 wherein the modifiable text is color coded.

11. The system of claim 9 further including a graphical user interface for selecting a unit of time describing at least one of a duration of symptoms for the medical condition, duration of medical treatment, amount of dosage for treating the medical condition.

12. The method of claim 9 wherein the chart is edited through at least one of a keyboard, mouse, or voice recognition software.

13. The method of claim 9 further including means for selecting at least one of a menu bar, navigation cube, title bar, or navigation tab.

14. The method of claim 9 further including means for deleting at least one of the modifiable and non-modifiable text from the chart using at least one of a keyboard, mouse, or voice recognition software.

15. The method of claim 9 further including means for adding at least one of a modifiable and non-modifiable text to the chart for describing the medical condition of the patient.

16. The method of claim 9 further including the means for storing multimedia information comprising at least one of an EKG, pictures, voice segments, of the patient.
